(19) United States
(12) Patent Application Publication
(10) Pub. No.: US 2008/0133858 A1
(43) Pub. Date: Jun. 5, 2008

(54) Secure Bit

(75) Inventors: Richard Enbody, East Lansing, MI (US); Krerk Piromsopa, East Lansing, MI (US)

Correspondence Address: HARNESS, DICKEY & PIERCE, P.L.C., P.O. BOX 828, BLOOMFIELD HILLS, MI, 48303, US

(73) Assignee: Board of Trustees of Michigan State University, East Lansing, MI (US)

(21) Appl. No.: 11/666,935

(22) PCT Filed: Nov. 3, 2005
(86) PCT No.: PCT/US05/39896

§ 371 Date: May 3, 2007

Related U.S. Application Data
(60) Provisional application No. 60/624,823, filed on Nov. 4, 2004.
(60) Provisional application No. 60/650,328, filed on Feb. 4, 2005.

(51) Int. Cl. G06F 12/14; G06F 13/24

(52) U.S. Cl. 711/163; 726/22; 710/260; 711/E12.091

(57) ABSTRACT

Prevention of buffer-overflow attacks on a computer system is presented. In another aspect of the present invention, a Secure Bit is associated with a memory location. A further aspect of the present invention involves modification of semantics to manage the Secure Bit. When the Secure Bit is marked, an interrupt or fault signal is generated.

### CROSS-REFERENCE TO RELATED APPLICATIONS

This application claims priority to U.S. Provisional Application No. 60/624,823, filed on Nov. 4, 2004 and U.S. Provisional Application No. 60/650,328, filed on Feb. 4, 2005, which are incorporated by reference herein.

### FIELD OF THE INVENTION

The present invention generally relates to prevention of malicious attacks to computer systems, and more particularly to prevention of buffer-overflow attacks.

### BACKGROUND OF THE INVENTION

Malicious code is a significant threat to computer systems. For example, malicious code may modify an environment variable, data, or a network packet. Any of these modifications potentially allows unfettered access to an operating system. One type of malicious code causes buffer-overflow attacks. A buffer-overflow attack manipulates memory operations to overflow a buffer. A successful buffer-overflow attack has two attributes. First, an address (e.g. return address, function pointer, etc.) is modified by overflowing a buffer. Second, the modified address is positioned to change a program flow. In most attacks, the target of the address is malicious code injected somewhere in memory (e.g. on a stack, a heap etc.) or resident shell code (i.e. user interface). These attacks typically occur in a privileged mode. If these two attributes of a buffer overflow attack are present, the attacker can assert control over a process (e.g., an operating system) of another user's computer.

Stack-based overflow exemplifies one type of buffer-overflow attack that targets a return address, a function pointer, or a stack frame pointer. A return address is a link to a calling site that allows a procedure to return to a proper address. A function pointer is a variable that points to an address of a function. A stack pointer is a register in the processor whose contents determine where data is to be pushed onto the stack. Stack-based overflow attacks modify a stack pointer that may change a value on the stack that relates to a return address or a function pointer. A return address or a function pointer may be indirectly modified, which causes the program flow to point to malicious code. Yet another type of buffer-overflow attack is heap/block started by symbol (BSS)-based overflow, which targets function pointers. Each of the above-mentioned attacks has a common characteristic, wherein a control address is corrupted for malicious purposes.

Conventional software and hardware techniques are unable to adequately protect the integrity of an address against buffer-overflow attacks. StackGuard exemplifies some of the problems associated with software techniques. StackGuard injects protective code into a program to protect a return address. Routines are then required to place a “canary word” after a return address. A canary word is a known value placed between a buffer and control data on the stack to monitor buffer-overflows. When the buffer-overflows, it “clobbers” the canary, which makes the overflow evident. StackGuard, however, may be compromised, if a return address is modified and a value of a canary word is maintained. StackGuard also creates overhead and reduces the performance of a computer.

Hardware approaches also fail to adequately protect the integrity of an address. One hardware approach referred to as Split Stack separates the control and the data stack to prevent a return address from being overwritten. While the Split Stack approach may protect against buffer-overflow attacks for a return address, it fails to prevent buffer-overflow attacks against function pointers.

Secure Return Address Stack (SRAS) is another hardware technique that addresses buffer-overflow attacks. SRAS maintains a redundant copy of the return address to validate return addresses. SRAS does not protect against function pointer attacks.

A variety of other software and hardware techniques, alone or in combination, are inefficient and may be compromised due to reliance on flawed software or coding specifications. Moreover, existing hardware and software buffer-overflow prevention techniques are incompatible with non-last in first out (non-LIFO) control. Additionally, some techniques use non-LIFO control flow in which a return address is constructed without a call instruction, thereby making it more difficult to prevent malicious attacks with existing techniques. It is therefore desirable to address these disadvantages associated with conventional processes.

### SUMMARY OF THE INVENTION

In accordance with the present invention, buffer-overflow attacks are prevented. In another aspect of the present invention, a Secure Bit is associated with a memory location. In one embodiment of the present invention, a management system for Secure Bit marks all memory words as secure except those memory words in buffers passed between processes. In another aspect of the present invention, a Secure Bit is set for a word in a buffer passed between processes. In still yet another aspect of the present invention, execution of call, return, and jump instructions cause a processor to check the Secure Bit. In a further aspect of the present invention, if a call, return, or jump instruction that the Secure Bit is set, the processor issues an interrupt or fault signal.

In yet another aspect of the present invention, semantics such as call, jump, and return instructions are modified to manage a Secure Bit. If the Secure Bit is set and an instruction uses that an address associated with a memory location as a target, the processor issues an interrupt or a fault signal.

In still yet another aspect of the present invention, when the Secure Bit is set on a return address and a return is executed, the processor issues an interrupt or a fault signal. In still yet another aspect of the present invention, when the Secure Bit is set on a function pointer and call or jump instructions are executed, the processor issues an interrupt or a fault signal.

Further areas of applicability of the present invention will become apparent from the detailed description provided hereinafter. It should be understood that the detailed description and specific examples, while indicating the preferred embodiment of the invention, are intended for purposes of illustration only and are not intended to limit the scope of the invention.

### BRIEF DESCRIPTION OF THE DRAWINGS

The present invention will become more fully understood from the detailed description and the accompanying drawings, wherein:

FIG. 1 is a block diagram of a system that prevents buffer-overflow attacks;

FIG. 2 is a block diagram of memory of the present invention;

FIGS. 3A-3B are block diagrams of memory that depict execution of instructions of the present invention;

FIG. 4 is a flow diagram of a method to prevent buffer-overflow attacks; and

FIG. 5 illustrates a block diagram that depicts another system of the present invention.

### DETAILED DESCRIPTION OF THE PREFERRED EMBODIMENTS

The present invention prevents malicious attacks on computer systems. In one embodiment, this is accomplished, in part, by adding a Secure Bit to a plurality of memory locations. Furthermore, a Secure Bit is added to all memory locations. The data for the Secure Bit and an address (e.g. a return address etc.) are stored in a Secure Bit and a memory location, respectively. Each memory location has its respective Secure Bit identified as secure, where the Secure Bit cleared to “0.” If, however, a memory location has passed as buffers between processes, the Secure Bit is identified as insecure, where the Secure Bit is set to “1.” If a memory location having a set Secure Bit is accessed as an address (e.g. by call, return, or jump instruction), a processor issues an interrupt or a fault signal.

The following terms shall include the following meanings throughout this application: “cleared” indicates that a bit has a value equal to “0;” “set” indicates that a bit has a value equal to “1;” and, a “marked” location, address, or pointer indicates that an associated Secure Bit is being set.

In another embodiment, this is accomplished, in part, by adding a Secure Bit to a memory location. When malicious code overwrites a return address in a particular memory location, a Secure Bit related to the particular memory location is set. A return instruction is configured such that a processor first checks the Secure Bit before processing the address overwritten by the malicious code. Since the Secure Bit is set, the processor does not process the return address placed in the memory location by the malicious attacker. Additionally, the processor issues the interrupt or faulty signal.

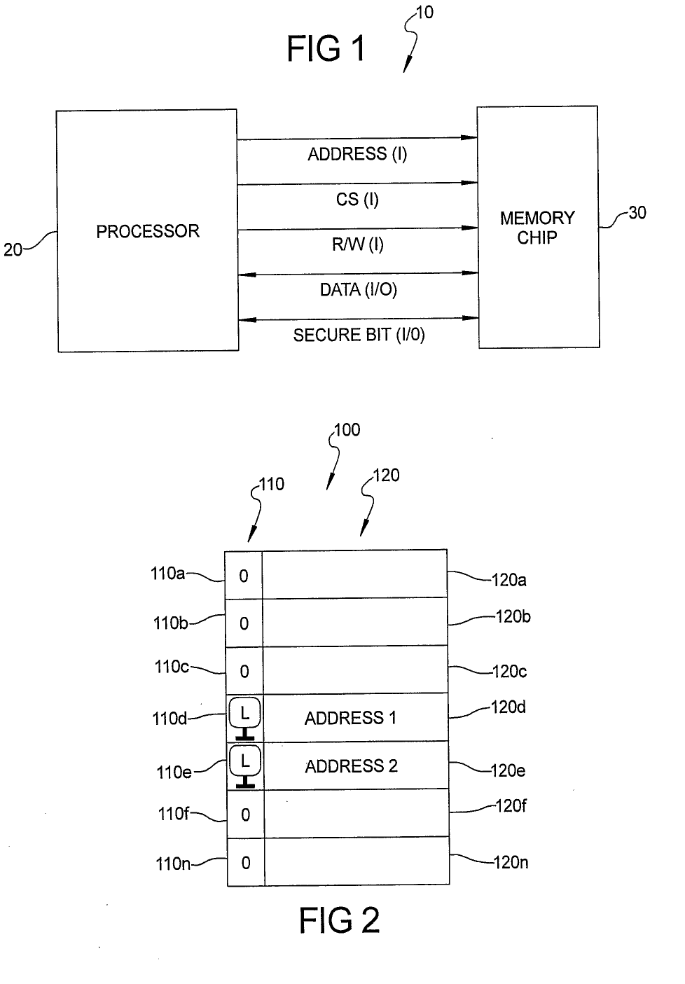

Details of the architecture and the protocols associated with the Secure Bit are presented below. FIGS. 1 through 5 show a system 10 that protects the integrity of addresses against buffer-overflow attacks. System 10 includes a processor 20 and a memory 30. Processor 20 transfers data related to addresses, chip select (CS), and read/write (R/W) over conductive lines (e.g., wires, interconnect, etc.) to memory 30. Data transfer between processor 20 and memory 30 occurs over another conductive line(s). Additionally, a conductive line for input and output of data related to the Secure Bit is connected between processor 20 and memory 30.

FIG. 2 is a block diagram of memory 100 (e.g., stack, etc.). Memory 100 comprises a plurality of security bits 110a-n that is associated with a plurality of memory locations 120a-n (e.g., addresses, memory words, words defined by a particular processor, etc.). For example, security bit 110a is associated with memory location 120a, security bit 110b is associated with memory location 120b, and security bit 110n is associated with memory location 120n, where n is the total number of memory locations. A marked memory location may be indicated by an associated security bit being set.

It is desirable to allow memory management functions to be implemented on the Secure Bits and memory locations. To facilitate memory management functions by an operating system, a Secure-bit mode (“sbit_mode”) is created to allow the Secure Bits to be moved between domains (e.g., processes etc.). The sbit_mode is associated with a secure-bit flag (i.e. sbit_mode_flag) in the processor. If the sbit_mode is activated or “ON,” the sbit_mode_flag in the processor will be set and moving buffers between domains (processes) causes the Secure Bit to be set. On the other hand, if the sbit_mode is deactivated or “OFF,” the sbit_mode_flag is cleared in the processor. For example, when the sbit_mode_flag is set to “1,” the move instruction sets the Secure Bit as it moves the words at its associated address. Otherwise, Secure Bits associated with any memory location cannot be changed by a move instruction, when the sbit_mode is “OFF.”

One aspect of the present invention includes a set of rules to implement the Secure Bits and memory locations. To facilitate the implementation of the Secure Bits, a Secure Bit of a result of an arithmetic operation is a logical “OR” of the operands, assuming the Secure Bit of an immediate value is “0.” Furthermore, a Secure Bit of an address building instructions, e.g. LEA or similar, is a logical “OR” of the Secure Bits of the operands. Additionally, if the sbit_mode is set, then a move instruction will set the Secure Bit. Otherwise, if the sbit_mode is cleared, a move instruction will copy the Secure Bit.

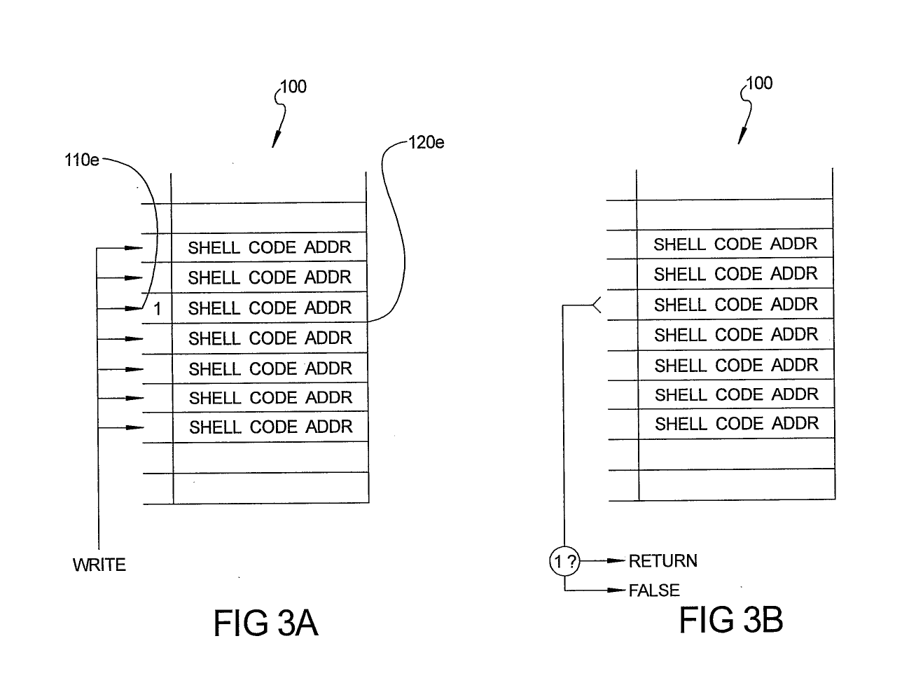

Under normal operations in which the sbit_mode is set, any modification to a memory location 120a-n from other operations always sets the Secure Bit 110a-n. For example, FIG. 3A illustrates that shell code addresses are written to a plurality of memory locations. Specifically, the shell code addresses overwrote a return address at memory location 120e. The Secure Bit 110e, associated with memory location 120e, is set to “1.” Referring to FIG. 3B, execution of the instruction (e.g., return instruction, jump instruction, etc.) at memory location 120e prompts processor 20 to first check the Secure Bit 110e to determine whether the Secure Bit 110e has been set. If the Secure Bit is cleared, the memory location is secure and the integrity of the address is intact. In contrast, if the Secure Bit is set, the address has been improperly modified through malicious or unexpected code. This is considered an interrupt or fault condition that is detected by processor 20. After detecting a set Secure Bit 110e, processor 20 generates an interrupt or fault signal. The interrupt or fault signal indicates that a malicious attacker modified the address.

An example of a method that prevents malicious code from obtaining control of an operating system is presented below. Initially, a program counter (PC) address is stored to memory 100 (e.g., stack). The PC is a register that contains the address of a current instruction in the program being executed. A Secure Bit is associated with a memory location for a particular address. A stack pointer is then increased to point to the next memory location. In the meantime, a malicious attack is launched to gain complete control of the operating system. The attack passes a buffer to this process and in a passing operation, Secure Bits associated with each word in the buffer is set. During the attack, the malicious code modifies the return address stored in memory 100. Since the return address has been modified, an associated Secure Bit had been set. A modified return address and its value of “1” for the associated Secure Bit are stored to memory 100. The stack pointer eventually points to the modified return address based upon, for example, a jump instruction. The jump instruction causes processor 20 to determine whether the associated Secure Bit with the modified return address is set or cleared. Since the Secure Bit is set, processor 20 automatically issues an interrupt or fault signal, which indicates that an error has occurred. The stack pointer is then decreased. A jump instruction may then be encountered. A jump is then made to another memory location. While a jump instruction is used in this example, other instructions may be similarly implemented. For example, a return instruction could be executed instead of the jump instruction. The return instruction operates in a manner similar to the jump instruction for managing the Secure Bit.

In another embodiment, a management system for Secure Bit marks all memory words as secure except those words in buffers passed between processes. A Secure Bit is set for a word in a buffer passed between processes. Executions of a call, return, or jump instruction causes processor 20 to check the Secure Bit. If the Secure Bit is set, processor 20 issues an interrupt or fault signal.

Instructions for the kernel of the operating system are configured to cause processor 20 to detect when a memory location in a buffer has been passed between processes. Table 1, presented below is an example of a set of instructions related to call, return, and jump instructions to manage the Secure Bit in order to prevent buffer-overflow. The call-indirect, return, and jump-indirect instructions then follow particular instructions inherent to each type of instruction.

TABLE 1
Call-indirect, return, and jump instructions for managing a Secure Bit.

| | | Jump-indirect |
|---|---|---|
| Call-indirect instruction | Return instruction | instruction |
| Validate the indirect | Validate return (target) | Validate the indirect |
| (target) address by | address by examining | (target) address by |
| examining its Secure | its Secure Bit. | examining its Secure |
| Bit. | | Bit. |
| If the Secure Bit of | If the Secure Bit of the | If the Secure Bit of the |
| target address is set, | target address is set, | target address is set, |
| issue a general | issue a general | issue a general |
| protection fault | protection fault | protection fault |
| signal/interrupt from the | signal/interrupt from | signal/interrupt from |
| processor. | the processor. | the processor. |

In addition, the following rules apply to other instructions:
1. The Secure Bit of a result of an arithmetic operation is the logical OR of the Secure Bits of the operands, assuming that the Secure Bit of an immediate value is “0” (cleared).
2. The Secure Bit of an address building instructions, e.g. LEA or similar, is the logical OR of the Secure Bits of the operands, assuming that the Secure Bit of an immediate value is “0” (cleared).
3. If the sbit_mode is set (“1”)
   a. then a move instruction will set the Secure Bit;
   b. otherwise, a move instruction will copy the Secure Bit.

In communication between a process and the operating system
1. If a buffer is passed and the operation is neither cloning nor spawning threads,
   a. then the sbit_mode will be set (“1”), so the Secure Bits of words in the buffer will be set (“1”);
   b. otherwise, the sbit_mode will remain cleared (“0”) and the Secure Bits of words will be copied.

Presented below is an exemplary function within an operating system kernel to implement management of a Secure Bit.

```
unsigned long
_generic_copy_to_user(void *to, const void *from, unsigned long n) {
  SET_SBITMODE( );
  if (access_ok(VERIFY_WRITE, to, n))
    _copy_user(to,from,n);
  CLR_SBITMODE( );
  return n;
}
```

SET_SBITMODE( ) and CLR_SBITMODE are the modifications.

These two lines of instructions are macros, i.e. short sets of instructions in the iX86 hardware language. The compiler substitutes these instructions for the word SET_SBITMODE( ) and CLR_SBITMODE( ):

```
// For Secure Bit 2
#define SET_SBITMODE( ) \
  asm volatile( \
    “ pushl %eax\n” \
    “ lahf\n” \
    “ orb $0x20, %ah\n” \
    “ sahf\n” \
    “ popl %eax” )
#define CLR_SBITMODE( ) \
  asm volatile( \
    “ pushl %eax\n” \
    “ lahf\n” \
    “ andb $0xdf, %ah\n” \
    “ sahf\n” \
    “ popl %eax” )
```

It should be appreciated that a variety of instructions may be used to modify the kernel function in order to achieve a similar result.

Numerous types of malicious attacks are prevented by having a Secure Bit associated with a memory location. One such malicious attack may try to create a Secure Bit in one domain (e.g. machine, process, etc.) and then move the Secure Bit to an address in another domain. Typically, passing a buffer between processes on a single machine requires invocation of the operating system kernel. The act of passing a buffer between processes, however always sets the Secure Bits in the buffer flagging the memory locations such that the memory location are not used as target addresses.

In another embodiment, neither the sbit_mode nor a Secure Bit can be moved between machines because communication channels between machines are designed not to pass them.

Other buffer-overflow attacks attempt to control a different process. For example, some buffer-overflow attacks attempt to control an operating system. Buffers passed to the operating system will have their Secure Bits set rendering them incapable of being used as target addresses.

In a system with Secure Bits, a potential attack attempts to disable the Secure Bit implementation in an operating system. By design, an attempt to modify the operating system directly is foiled by either the standard practice of storing operating system instructions in read-only memory or the standard practice of implementing the operating system in a separate ring.

Another embodiment of the present invention also protects against buffer-overflow attacks such as function pointer attacks. A function pointer is an address that points to a target routine. In this type of attack, malicious code modifies a function pointer to point to the injected (or resident) code. This attack proceeds without changing the return address. The attacked function pointer forces the program to execute the malicious code rather than calling the expected routine. Function pointer attacks are prevented because a pointer modified by a buffer will cause an associated Secure Bit to set. This prevents an address having the associated Secure Bit from being used. In this embodiment, a call or jump instruction validates a function pointer (target address) and the function pointer is valid only when the Secure Bit, associated with an address of a function pointer, is cleared. The Secure Bit is checked before execution of the function pointer.

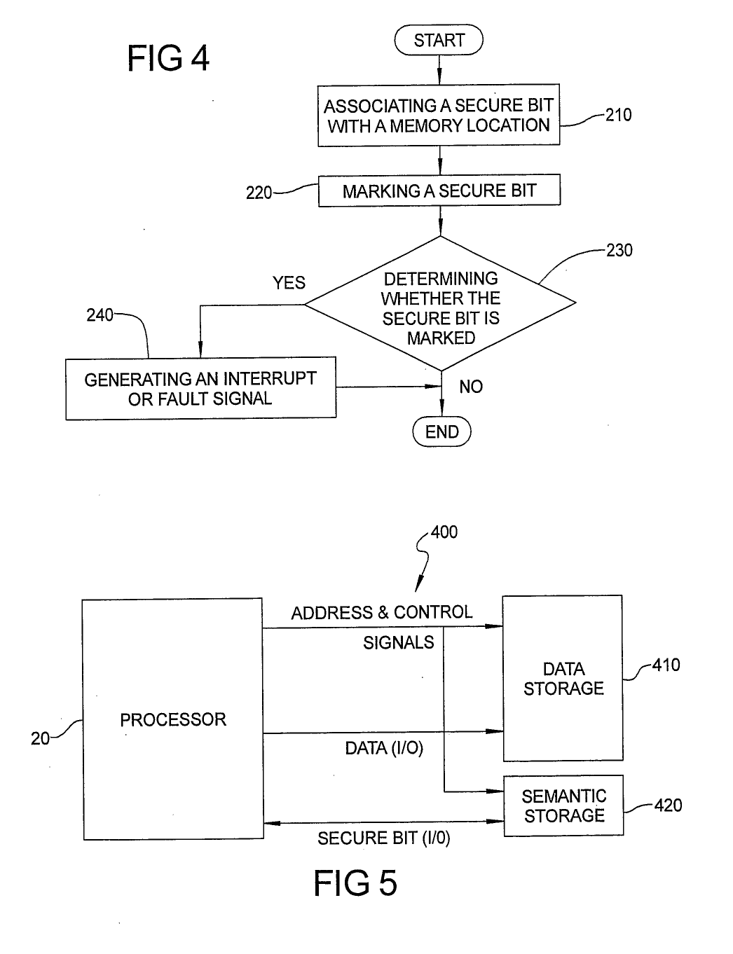

FIG. 4 is a flow diagram of a method for preventing buffer- overflow attacks. At operation 210, a Secure Bit is associated with a memory location. At operation 220, passing a buffer marks a Secure Bit. Marking a Secure Bit entails setting the Secure Bit. The Secure Bit is set when a memory location has been passed as a buffer between processes. At operation 230, the Secure Bit is checked before an address is accessed, e.g. by a return instruction, a jump instruction, or indirect call. At operation 230, a determination is made as to whether the Secure Bit is set. If the Secure Bit is not set, the processor recognizes that the address has not been modified by other instructions. If the Secure Bit is set, an interrupt or fault signal is generated from the processor.

FIG. 5 illustrates an alternate system 400 to prevent buffer-overflow attacks. A data storage 410 and a semantic storage 420 for a Secure Bit are interleaved using a separate interface. While data lines have a byte boundary, the semantic line has a bit boundary. This separation between the data and semantic storage creates a simple memory controller that converts a bit interface of the Secure Bit to access legacy byte boundary memory chips.

A notable aspect of the above-mentioned embodiments is that there is no mechanism for clearing a set Secure Bit. That is, once a Secure Bit has been set in a buffer, there is no way to clear it. In particular, such an instruction for clearing the bit is not needed. Of particular importance to secure operation, clearing a Secure Bit cannot be a vector of attack on the management of the scheme. A set Secure Bit may be implicitly cleared, however, by overwriting a word having the set Secure Bit with a word that has an associated Secure Bit cleared, i.e. overwrite with a local word that did not come by way of a buffer.

Another notable aspect of the above-mentioned embodiments is that the Secure Bits allow a system to perform a method to check the integrity of data associated with a memory location. Furthermore, the underlying strategy to implementing the Secure Bits is to set the Secure Bits when data associated with the Secure Bits as buffers are passed into a process, the data is marked as insecure. Thus, the Secure Bit related to such data is set. When a process tries to use one of the marked pieces of data as control data, a signal is produced to indicate that the data is insecure.

Numerous types of malicious attacks are prevented by having a Secure Bit associated with a memory location. One such malicious attack may try to create a Secure Bit in one domain (e.g. machine, process, etc.) and then move the Secure Bit to an address in another domain. This action would cause the Secure Bits to be set. Typically, passing a buffer between processes on a single machine requires invocation of the operating system kernel. This type of move will cause Secure Bits to be set. In another embodiment, neither a sbit_mode nor a Secure Bit can be moved between machines because communication channels between machines are designed not to pass them and any information passing between machines will invocate the operating system kernel that will cause the Secure Bits to be set.

Other buffer-overflow attacks attempt to control a different process. For example, some buffer-overflow attacks attempt to control an operating system. To address this type of attack, domains are distinguished between processes by the trap instruction. Execution of a trap instruction prevents a sbit_mode from being copied from a buffer of one process to a buffer in another process. This is accomplished by modifying the semantics of the trap instruction to save the sbit_mode for later restoration. This allows the process (e.g., function pointers, non-LIFO control, etc.) to manage the Secure Bit within its own domain but the process cannot pass the sbit_mode across domains.

The Secure Bit also addresses non-LIFO problems. Non-LIFO control flow poses a problem for buffer-overflow schemes since a return address on the stack may not have been created by a corresponding call instruction. Some examples appear as an optimization of some compilers or an implementation of specific languages such as exception handling in C++. Additional examples of non-LIFO control appear in object C code, the use of trampolines, and with the long jump instruction. In all cases, if the integrity of addresses is preserved, the order of control does not matter. For example, assume A calls B, B calls C, and C calls D, respectively. D can directly return to A with a long jump instruction. If the return address does not have Secure Bit set, it causes no problem with the present invention. However, there are also situations that the return address is not created by a call instruction. In another example, a signal handling protocol in the Linux kernel returns to a signal handling routine without a call from that particular routine.

It should be further understood that various alterations could be made to the present invention. For example, a Secure Bit may be marked by clearing the bit whereas Secure Bits set to “1” indicate secure data and Secure Bits cleared to “0” indicate insecure data. Additionally, the Secure-bit mode may be activated when the sbit_mode flag is cleared to “0” instead of being set to “1.” It will be appreciated that more or fewer processes may be incorporated into the methods described herein without departing from the scope of the invention and that no particular order is implied by the arrangement of blocks shown and described herein. It can be appreciated that the methods described herein may be embodied in machine-executable instructions or statements (e.g., software). The instructions can be used to cause a general-purpose or special-purpose processor that is programmed with the instructions to perform the operations described. Alternatively, the operations may be performed by specific hardware components that contain hard-wired logic for performing the operations, or by any combination of programmed computer components and custom hardware components. The methods may be provided as a computer program product that may include a machine-readable medium having stored thereon instructions which may be used to program a computer (or other electronic devices) to perform the methods. For the purposes of this specification, the terms “machine-readable medium” includes any medium that is capable of storing or encoding a sequence of instructions for execution by the machine and that cause the machine to perform any one of the methodologies of the present invention. The term “machine-readable medium” includes, but is not be limited to, solid-state memories, optical and magnetic disks, and carrier wave signals. Furthermore, it is common in the art to speak of software, in one form or another (e.g., program, procedure, process, application, module, logic, statement etc.), as taking an action or causing a result. Such expressions are merely a shorthand way of saying that the execution of the software by a computer causes the processor of the computer to perform an action or to produce a result.

The description of the invention is merely exemplary in nature and, thus, variations that do not depart from the gist of the invention are intended to be within the scope of the invention. Such variations are not to be regarded as a departure from the spirit and scope of the invention.

1. A method for preventing a malicious attack from controlling a process comprising:
associating a secure bit with memory location, the secure bit indicative of security of the memory location;
clearing the secure bit whenever a write instruction is executed in relation to the memory location;
setting the secure bit when executing a call instruction that places a return address in the memory location; and
checking the secure bit before accessing the return address in the memory location.

2. The method of claim 1, further comprising: accessing the return address in the memory location when the secure bit is set and issuing an interrupt when the secure bit is cleared.

3. The method of claim 1, further comprising:
associating a mode (“sbit_mode”) with a processor; and
preserving integrity of the address.

4. The method of claim 3, further comprising:
setting the secure bit when a write instruction overwrites the address and the sbit_mode is set.

5. The method of claim 1, wherein marking the secure bit further comprises:
determining whether the memory location has passed in a buffer in a process or between processes.

6. The method of claim 5, wherein determining further comprises:
setting the secure bit when the memory location has passed in the buffer in the process or between the processes.

7. The method of claim 5, wherein determining further comprises:
setting the secure bit when a write instruction overwrites the address and the sbit_mode is activated.

8. The method of claim 5, further comprising: generating an interrupt or fault signal.

9. The method of claim 5, wherein determining further comprises:
maintaining the value of the secure bit when the memory location has not passed in the buffer in the process or between the processes.

10. The method of claim 1, wherein the address is any address used as control data.

11. The method of claim 1, further comprising:
managing the secure bit through a plurality of instructions.

12.-19. (canceled)

20. A method for preventing a malicious attack on a computer comprising:
adding a secure bit to a memory location;
associating a secure-bit mode with a processor, wherein the secure-bit mode dictates when the secure bit can be set
setting the secure bit when the secure-bit mode is activated and the memory location is moved as a buffer between domains;
checking the secure bit prior to executing an instruction that accesses the memory location; and
issuing a signal when the secure bit associated with the memory location is set.

21. The method of claim 20, wherein the signal is a fault signal.

22. The method of claim 20, wherein the signal is an interrupt signal.

23. The method of claim 20, further comprises:
configuring a set of instructions operable to implement a trap instruction configured to transfer control between processes.

24. The method of claim 23, wherein the trap instruction saves the sbit_mode for restoration when control returns to at least one of the processes and clears the sbit_mode for a new process.

25. The method of claim 22, wherein the trap instruction prevents the at least one secure bit from moving between processes.

26. The method of claim 20, wherein n bits are associated with n words.

27. The method of claim 20, further comprises:
setting at least one bit in a processor, when the secure-bit mode is activated.

28. The method of claim 27, wherein the at least one bit comprises a secure mode flag bit to activate the secure-bit mode.

29. The method of claim 20, further comprises:
clearing the at least one bit in a processor, when the secure-bit mode to deactivated.

30. The method of claim 29, wherein the at least one bit is a secure-mode flag bit to activate the secure-bit mode.

31. The method of claim 20, further comprises:
configuring a set of instructions operable to implement a move instruction to mark the at least one secure bit as the secure-bit mode is activated and the memory location has passed as buffers between domains or processes.

32. The method of claim 20, further comprises:
setting the at least secure bit.

33. The method of claim 32, wherein the secure bit is set when the secure-bit mode is activated and the associated memory location moves as in a buffer between domains or processes.

34. A computer system comprising:
a processor coupled to a memory, the memory having stored therein instructions which when executed by the processor causes the processor to:
(a) generate data;
(b) associate a secure bit to a memory location, the secure bit indicative of security of the memory location;
(c) clearing the secure bit whenever a write instruction is executed in relation to the memory location;
(d) setting the secure bit when executing a call instruction that places a return address in the memory location;
(e) checking the secure bit before accessing the return address in the memory location and an interconnect coupled to the processor and the memory to allow the data to be transferred between the memory and the processor.

35. The computer system of claim 34, wherein the processor configures a set of instructions operable to implement at least one of:
(a) a secure-bit mode which determines when the secure bit can be written;
(b) a call instruction to check validity of the address;
(c) a return instruction to check validity of the address; and
(d) a jump instruction to check validity of the address.

36. The computer system of claim 35, wherein the processor configures any write instruction outside of a secure-bit mode to copy the secure bit.

37. The computer system of claim 35, wherein the processor configures only a write instruction during the secure-bit mode to set the secure bit.

38. The computer system of claim 34, wherein the processor determines whether the secure bit associated with the memory location passed as buffers in a process or between processes.

39. The computer system of claim 38, wherein the processor configures a set of instructions operable to implement a secure-bit mode which determines when the secure bit can be written.

40. The computer system of claim 38, wherein the processor configures a set of instructions to implement a move instruction to mark the secure bit.

41. The computer system of claim 34, wherein the processor configures a set of instructions operable to implement at least one of the following:
(a) the secure bit of an immediate value equals “0;”
(b) the secure bit of a result of an arithmetic operation is a logical “OR” of a plurality of secure bits of an operands, when the secure bit of an immediate value equals “0;”
(c) the secure bit of an address building instructions is a logical “OR” of a plurality of secure bits of the operands, when the secure bit of immediate value equals “0;”
(d) a move instruction sets the secure bit, when a secure-bit mode is activated; and
(e) a move instruction copies the secure bit, when a secure- bit mode is deactivated.

42.-56. (canceled)

57. A method for preventing a malicious attack against a computer system comprising:
associating a secure bit to a memory location;
executing an instruction;
associating an address to the memory location;
setting the secure bit; and
detecting a malicious attack when the first secure bit is cleared.

58. The method of claim 57, wherein detecting further comprising detecting the malicious attack when the address is accessed and the secure bit is found to be set.

59. The method of claim 57, wherein detecting the malicious attack occurs through the instruction.

60. The method of claim 57, wherein the instruction requires a processor to first check the secure bit.

61. The method of claim 57, wherein the instruction includes at least one of a call instruction, a return instruction, and a jump instruction.

62. A method for preventing a malicious attack on a computer comprising:
adding at least one bit to a memory location to determine whether data associated with the memory location is a valid;
associating a write mode with a processor;
determining through the write mode when the at least one bit can be written; and
determining whether the data came from a buffer passed in a process or between processes.

63. The method of claim 62, wherein the write mode is set when the buffer is passed in the process or between processes.

64. The method of claim 62, wherein write instructions set the bit only when the write mode is set.

65. A method comprising:
adding a secure bit to each memory location to protect against a buffer-overflow attack; and
managing the secure bit through a plurality of instructions to prevent a buffer-overflow attack.

66. The method of claim 65, wherein one of the instructions of the plurality of instructions is an instruction which sets a secure bit write mode.

67. The method of claim 65, further comprising:
protecting against buffer-overflow.

68.-72. (canceled)

73. A method for preventing a malicious attack, comprising:
associating a single, secure bit with a memory location, the secure bit indicative of security of the memory location;
setting the secure bit when executing a call instruction that places a return address in the memory location; and
checking the secure bit before accessing the return address in the memory location.

74. The method of claim 73 further comprises checking the secure bit upon executing a return instruction.

75. The method of claim 73 further comprises checking the secure bit upon executing a jump instruction.

76. The method of claim 73 further comprises accessing the return address in the memory location when the secure bit is set.

77. The method of claim 73 further comprises issuing an interrupt when the secure bit is cleared.

78. The method of claim 73 further comprises clearing the secure bit whenever a write instruction is executed in relation to the memory location.
